(19) United States
(12) Patent Application Publication
(10) Pub. No.: US 2007/0261030 A1
(43) Pub. Date: Nov. 8, 2007

(54) Method and system for tracking and prioritizing applications

(76) Inventor: Gaurav Wadhwa, Haryana (IN)

Correspondence Address: KENYON & KENYON LLP, RIVERPARK TOWERS, SUITE 600, 333 W. SAN CARLOS ST., SAN JOSE, CA, 95110, US

(21) Appl. No.: 11/429,131

(22) Filed: May 4, 2006

(51) Int. Cl. G06F 9/44

(52) U.S. Cl. 717/127

(57) ABSTRACT

In a method and system for tracking a computer operator's application usage and organizing the applications by use and priority level, usage by a computer operator of computer applications is tracked over time. The tracked usage of the applications for a predetermined time interval is recorded. A user interface is presented to the operator via a computer display, with the user interface presenting a list of selected applications ordered according to a predetermined priority assignment. With respect to applications having a common priority assignment, the applications are ordered according to tracked usage levels.

### BACKGROUND

Today's computer systems often contain hundreds or thousands of applications. Users of these computer systems, however, may only use a small percentage of the available applications. Furthermore, multiple users may use different applications in a computer system. The computer system, however, does not track the use of the applications over a period of time, nor does it distinguish between applications used by different users.

Some computer systems do possess a limited memory of application or file accesses. One way this type of limited memory may be implemented is by using a buffer file that keeps a list of files or applications accessed in the order of most recently accessed to least recently accessed. For instance, computers running a version of the Microsoft Windows operating system may list the ten most recently accessed files in reverse order in the “Start” menu. As different files or applications are used, the least recently accessed file or application is removed from the list of files or applications and replaced by the most recently accessed file or application. Another method of implementing a limited memory system may be illustrated in some versions of Microsoft Windows where programs or applications used frequently may be displayed and accessed in the Programs tab of the Start menu, while programs or applications infrequently or never used may be hidden in the Programs tab unless the user chooses an option to display all programs. If a hidden program is accessed, then the next time the Programs tab is accessed, the previously hidden program becomes visible. Both limited memories however are rudimentary methods of remembering a user's application access history and do not accurately reflect a user's true use of the applications in a computer system.

What is needed is a system that tracks a user's application use over a period of time and presents the user with links to the applications organized by frequency of use and priority.

### BRIEF DESCRIPTION OF THE DRAWINGS

The invention is described in detail with reference to the following drawings wherein like numerals reference like elements, and wherein:

FIG. 1 illustrates a computer system for tracking and prioritizing applications.

FIG. 2 illustrates a computer system for tracking and prioritizing applications.

FIG. 3 illustrates a computer system used to back up usage frequency data.

FIG. 4 illustrates a flowchart for tracking and prioritizing applications.

FIG. 5 illustrates a flowchart for creating and displaying menus containing links to applications organized by priority level and usage frequency.

FIG. 6 illustrates a flowchart for backing up usage frequency data.

FIG. 7 illustrates an interface to display usage menus.

### DETAILED DESCRIPTION

Embodiments of the present invention provide a method and system for tracking and prioritizing installed applications. The method tracks a computer operator's usage of computer applications over time. Tracked usage of the applications over a predetermined time interval is then recorded. A user interface is presented to the computer operator using a computer display. The user interface presents a list of selected applications ordered according to a predetermined priority assignment. With respect to applications having a common priority assignment, the applications are ordered according to tracked usage levels.

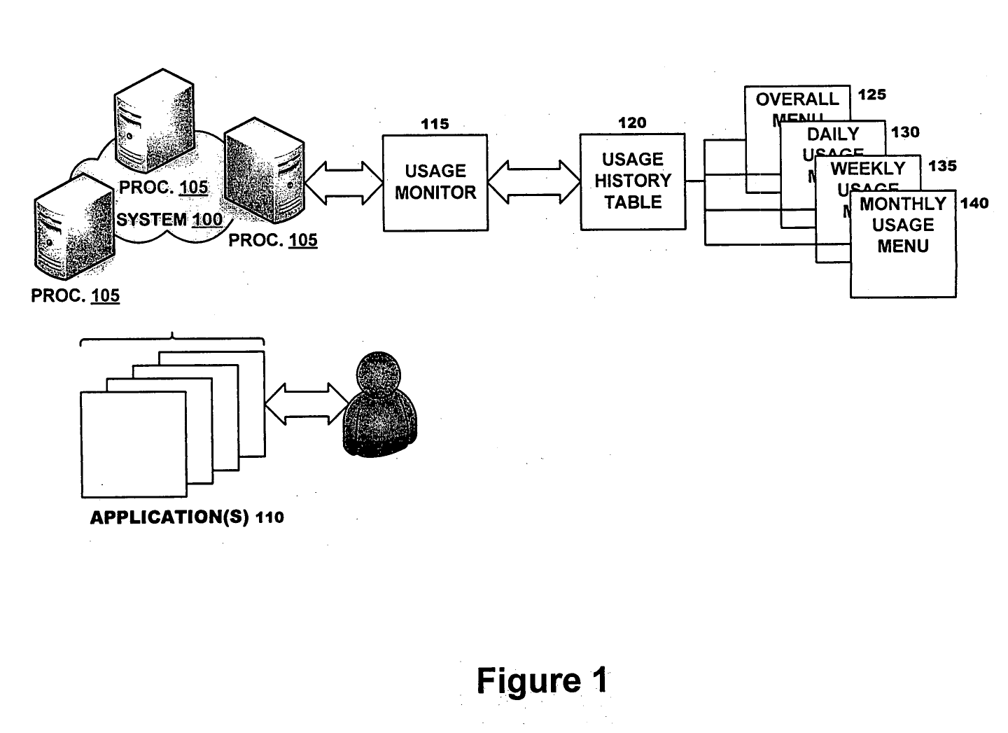

FIG. 1 illustrates a computer system for tracking and prioritizing applications according to an embodiment of the present invention. The computer system 100 may include one or more processor(s) 105 having multiple applications 110 installed thereon. The computer system 100 may be embodied as a single computer terminal or a computer network; the organization and architecture of the system 100 are immaterial to the present discussion unless otherwise noted. The system 100 may include a usage monitor 115 which observes the input of a network user with respect to the installed applications. Data representing usage patterns and generated from the observations of the input of the network user may be inserted into a usage table 120 by the usage monitor 115. From data in the usage table, the usage monitor 115 may generate various usage menus 125-140, which may be presented to network users through a user interface, for example, as a convenient tool through which to navigate among and open applications.

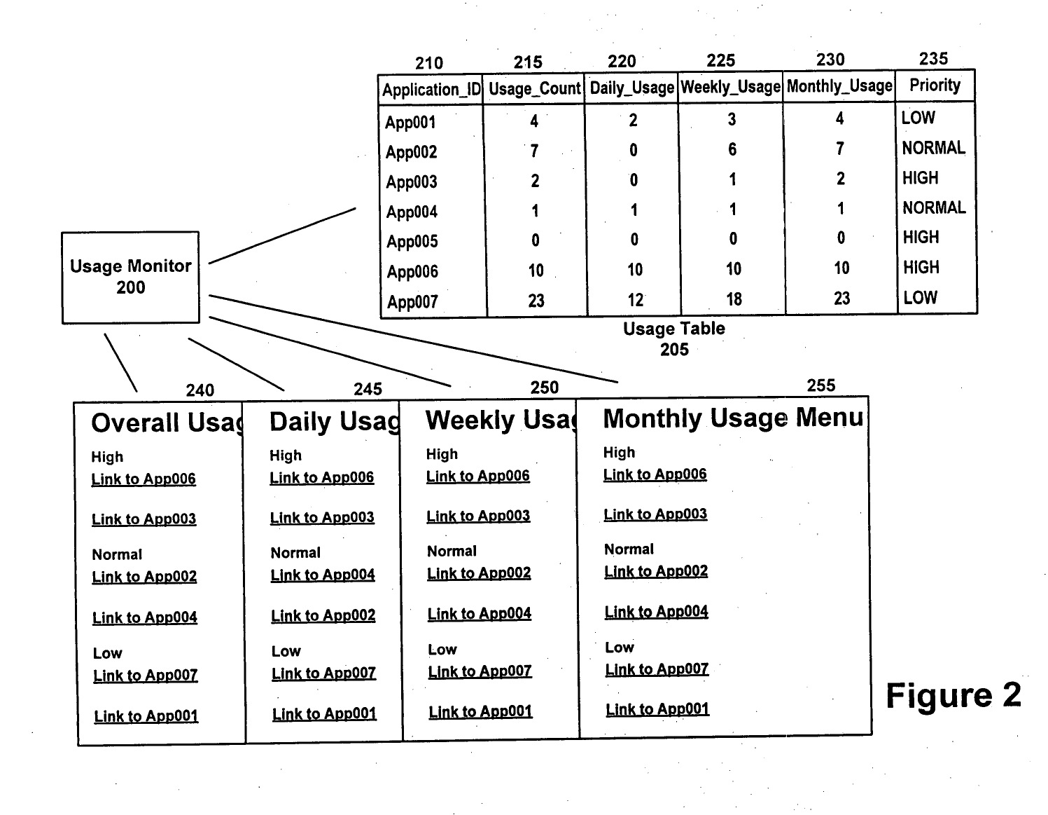

FIG. 2 illustrates a computer system for tracking and prioritizing applications according to an embodiment of the present invention. A usage monitor 200 may be included within a computer system. A usage table 205 may hold a list of installed applications as one of its fields. Each application may be listed by a unique application identifier, for example, an Application_ID 210. The usage table 205 may also contain fields devoted to the tracked usage of the respective applications at various temporal granularities. The tracked usage, embodied as the Usage_Count 215, may be defined as the number of times an application is accessed by a user over all time. Tracked usage for predetermined time intervals may also be tracked by the usage monitor 200 and recorded in fields in the usage table 205. For example, predetermined time intervals may include daily, weekly, and monthly. In other installations, where usage is expected to vary during different parts of a calendar year, the time intervals may relate to intervals of a fiscal year (e.g. first, second, third, and fourth quarters). Tracked usage counters corresponding to these predetermined time intervals may be labeled in the usage table 205 as Daily_Usage 220, Weekly_Usage 225, and Monthly_Usage 230. The usage monitor 200 tracking a computer operator's application usage may update one or more tracked usage fields simultaneously in connection with an application being accessed by the computer operator. A field in the usage table 205 labeled Priority_Level 235 may also be devoted to the priority level assigned to each application. In one embodiment, priority levels may include low, normal, or high. Alternatively, priority level names may be assigned by the operator or an administrator. Each application may by default be assigned a priority level of normal. In one embodiment, priority levels may be changed or assigned by either the computer operator or the administrator.

Using the data stored in the usage table 205, the usage monitor 200 may create one or more menus containing links or command pathways to the applications organized by the tracked usage for a predetermined time interval as well as the priority level assigned to the application. In one embodiment shown as FIG. 2, four menus containing links to the applications installed may be created. Links or command pathways to the applications in each of the menus may be organized using data from different predetermined time intervals. Thus, links to applications in one menu may be organized by priority level and a daily tracked usage, as shown by the menu labeled “Daily Usage Menu” 245, while links to applications in a second menu may be organized by priority level and a weekly tracked usage, as shown by the menu labeled “Weekly Usage Menu” 250, and so forth. Furthermore, one of the menus created may contain links to applications organized by the priority level and the overall tracked usage of each application, as shown by the menu labeled “Overall Usage Menu” 240. In one embodiment, a user interface may present the menus to a computer operator. Alternatively, the user interface may present a list of applications or command pathways to the applications tracked over a predetermined time interval to the operator. In one embodiment, the user interface also may present the menus, links, or command pathways to the operator only after the operator has been authenticated. The computer operator thus may have easily accessible links to high priority or frequently used applications upon logging into the computer system.

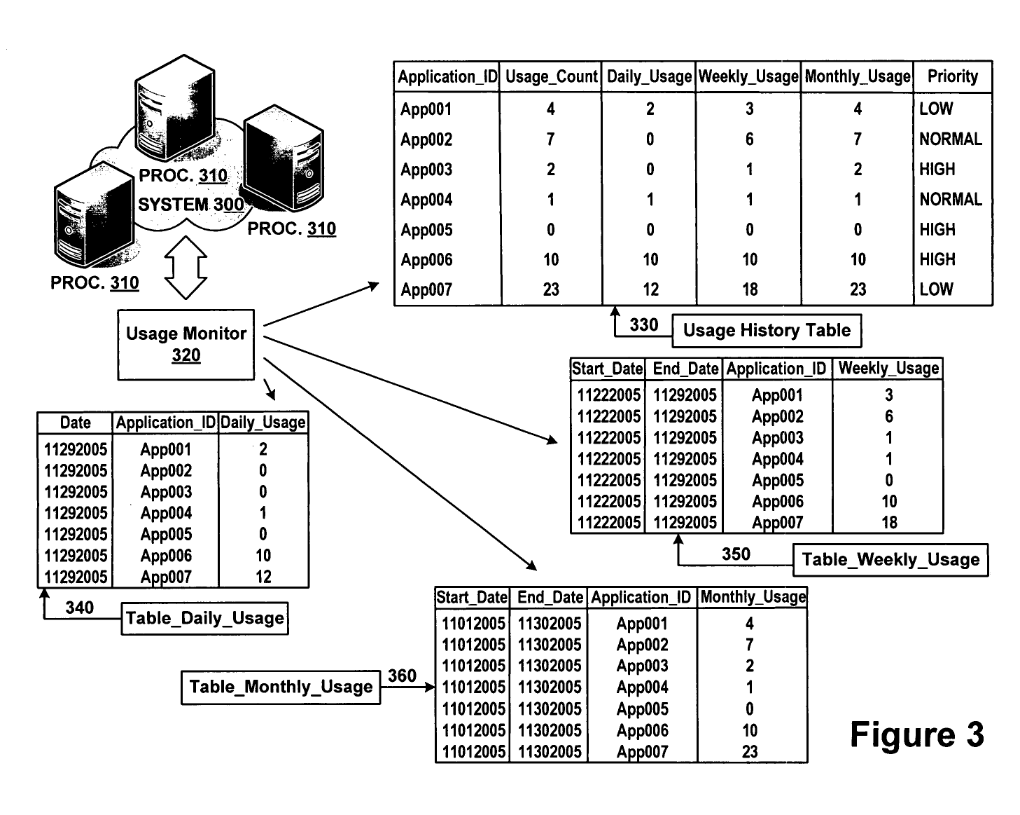

FIG. 3 illustrates a computer system for backing up tracked usage data. A computer system 300 with one or more processors 310 and a usage monitor 320 may store or create a usage table 330 and backup tables 340, 350, and 360. Because the usage monitor 320 tracks and stores application usage for a predetermined time interval in a usage table 330, upon the expiration of that predetermined time interval, the tracked usage stored in the usage table 330 may need to be reset to account for the onset of the next time interval. Thus, to prevent erasure of the tracked usage data, the tracked usage for each corresponding time interval may be transferred to a corresponding backup table. In one embodiment, backup tables may be created so that a backup table exists for each predetermined time interval. In one embodiment, three backup tables may be created to account for the predetermined time intervals of a day, a week, and a month. Each backup table may track the date or range of dates for which the tracked usage data applies, as shown by the Date field in the table marked Table_Daily_Usage 340 or by the Start_Date and End_Date fields in the tables labeled Table_Weekly_Usage 350 and Table_Monthly_Usage 360. Each backup table may also list in a separate field the application for which the usage was tracked, as shown by the Application_ID field present in all three backup tables in FIG. 2. Each backup table may also contain the tracked usage for the respective predetermined time intervals, as shown by the Daily_Usage, Weekly_Usage, and Monthly_Usage fields found in the three backup tables.

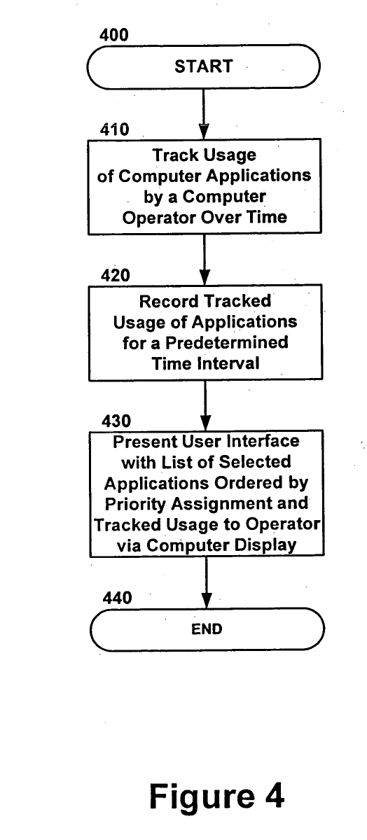

FIG. 4 illustrates a flowchart for tracking and prioritizing a computer operator's use of applications installed in a computer system. In block 410, a computer system 100 may track the usage of applications 110 installed within the computer system 100 by a computer operator over time. In one embodiment, the computer system 100 may begin tracking the computer operator's usage for the applications 110 after the operator is authenticated on the system 100. The tracked usage for each authenticated operator may be separately tracked and maintained by the computer system 100. In block 420, the computer system 100 may record tracked usage of applications over a predetermined time interval. In one embodiment, the tracked usage may be recorded in a usage table. In one embodiment, where application usage over multiple time periods is being tracked, in order to reduce the amount of resources used by the computer system 100, the system 100 may record the tracked usage only at the expiration of a predetermined time interval. Thus, if the predetermined time intervals for tracking application use by the computer operator are daily, weekly, and monthly, then the computer system 100 may record the daily tracked usage at the end of every day without updating the weekly and monthly tracked usages. At the end of the week, the computer system 100 may record both the daily tracked usage and the weekly tracked usage, but not the monthly tracked usage. At the end of the month, the computer system 100 may record the daily, weekly, and monthly tracked usages. In block 430, a user interface may be presented to the computer operator via a computer display. The user interface may present a list of selected applications ordered according to a predetermined priority assignment. Applications having the same priority assignment may be ordered according to tracked usage levels. The predetermined priority assignment may categorize the applications for the user's benefit. By default, each application may be assigned a normal priority level. In one embodiment, instead of presenting a user interface to the computer operator, priority levels may be assigned for each application. Menus or lists containing links or command pathways to the applications may be created with the applications being ordered within the menus or lists by assigned priority levels and tracked usage levels. The process ends in block 440.

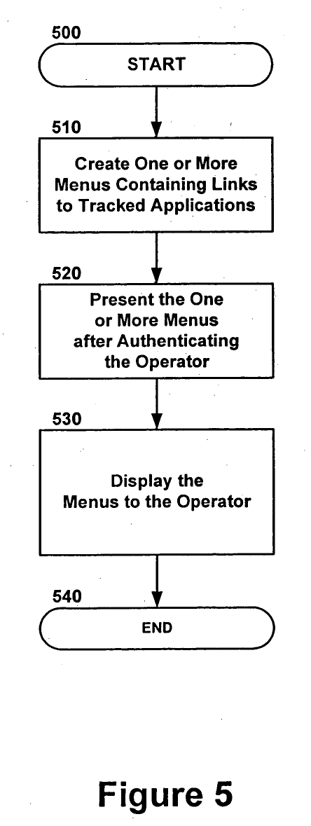

FIG. 5 illustrates a flowchart for creating and presenting lists or menus containing links or command pathways to applications organized by tracked usage and priority level to a computer operator. In block 510, a computer system 100 may create one or more menus or lists corresponding to the one or more predetermined time intervals used in tracking an operator's application usage. In one embodiment, these menus or lists may be text files, web pages, buffer files, or database tables. Each menu or list may contain links or command pathways to the tracked applications, thus providing the operator with shortcuts to the applications. In each menu or list, the applications may first be organized by their priority level. Links to each application may then be further sorted by tracked usage in order of most frequently used to least frequently used. In block 520, after an operator logs onto a computer system 100 and is authenticated, the computer system 100 may load or present the menus or lists to the operator through a user interface. In block 530, the computer system 100 may display the menus or lists to the operator through the use of a graphical or computer display. Thus, the operator may have access to the application links immediately upon logging onto the system 100 and may be able to use frequently used applications or applications the operator has deemed a high priority. The process ends in block 540.

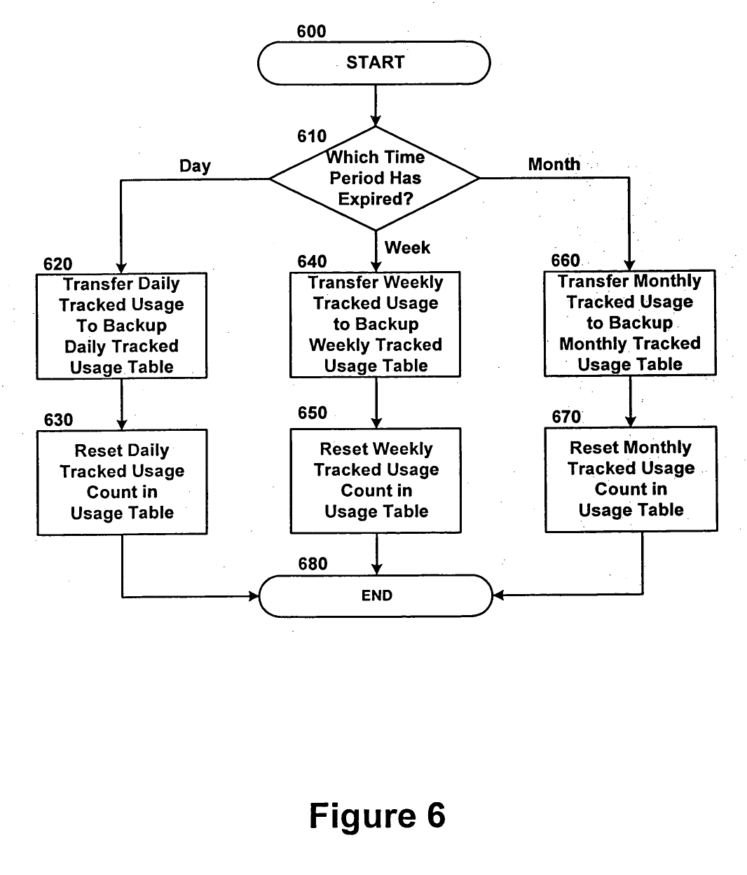

FIG. 6 illustrates a flowchart for backing up tracked usage data for different predetermined time intervals. In block 610, a usage monitor 320 in a computer system 300 may back up tracked usage data depending on which predetermined time interval has expired. In one embodiment, in order to reduce the amount of resources consumed in backing up tracked usage data, the usage monitor 320 in the computer system 300 may wait until the expiration of a predetermined time interval to back up tracked usage data. If the expiring predetermined time interval is a day, then in block 620, the usage monitor 320 may transfer the daily tracked usage data from the usage table 330 to the table labeled Table_Daily_Usage 340 as seen in FIG. 3. Other data, such as the date the data was collected and the application to which a particular tracked usage applies, may also be inserted in the Table_Daily_Usage 340 corresponding to the daily tracked usage data transferred from the usage table 330. In block 630, the daily tracked usage counter for each application listed in the usage table 330 may be reset to zero to account for the next day.

If the expiring predetermined time interval is a week, then in block 640, the usage monitor 320 may transfer the weekly tracked usage data from the usage table 330 to the table labeled Table_Weekly_Usage 350. In addition to the tracked usage data being copied to the Table_Weekly_Usage 350, other data, such as the start and end dates for the week the tracked usage data was collected and the application to which a particular tracked usage applies, may be inserted into the Table_Weekly_Usage 350. Thus, a record in the Table_Weekly_Usage 350 may include the start and end dates of the week the tracked usage data was collected, along with the application ID of the application the operator accessed, and the weekly tracked usage count. In block 650, the usage monitor 320 may reset the weekly tracked usage counter for each application listed in the usage table 330 to account for the new week. In block 660, similar methods may be used to copy the monthly tracked usage data from the usage table 330 to the backup table labeled Table_Monthly_Usage 360. A record in the Table_Monthly_Usage 360 may include the start and end dates of the month from which the tracked usage data was collected as well as the application ID of the application the operator accessed, and the monthly tracked usage count for the particular application. In block 670, the usage monitor 320 may reset the monthly tracked usage found in the usage table 330 to zero to account for the new month. The process ends in block 680.

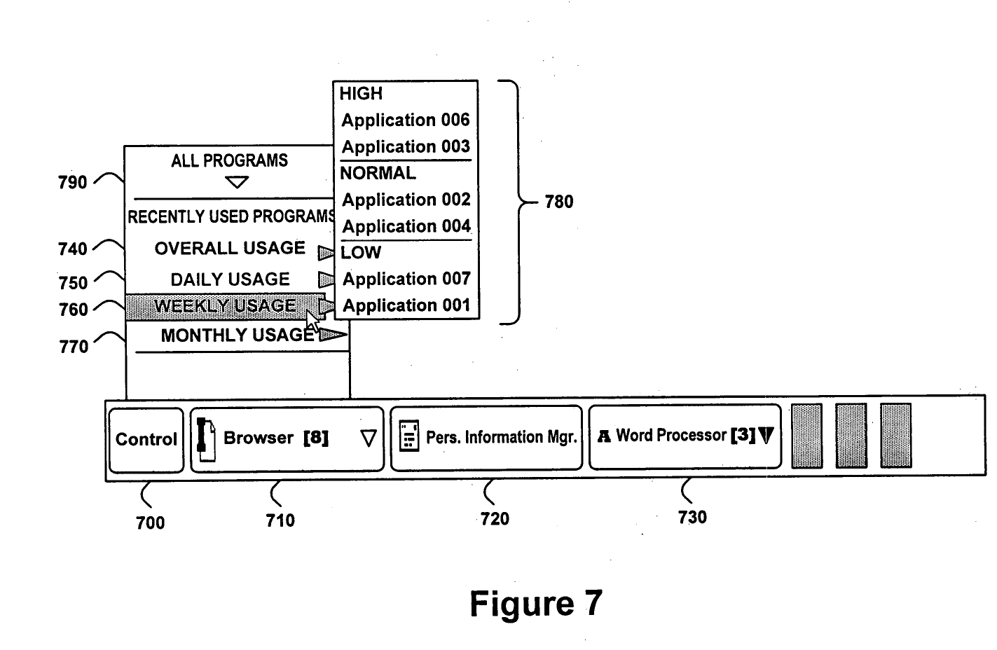

FIG. 7 illustrates an interface to display usage menus or lists. In one embodiment, the interface may be menu-driven with nested menus providing for greater organization and simplified access. The interface control 700 shown in the interface may be used to access various application programs or features installed in the computer system. Various group identifiers 710, 720, and 730, may also be present in the interface. The group identifiers 710, 720, and 730 may represent application programs active on a computer system. The browser 710, personal information manager 720, and word processor 730 identifiers are merely indicative of possible applications that may be active on a computer system. The usage menus or lists created by a usage monitor may be embodied and accessed in a nested menu format in the interface. Alternatively, each usage menu or list created by a usage monitor may be a separate file represented by an icon in the interface. Each file may be accessed by selecting the icon. If the usage menus are embodied in a menu format, then in a first nested menu, a computer operator may be presented with a list of menus available to be selected. This list of menus may reflect and be organized by the different predetermined time intervals used to track usage of applications. This list of menus may include an Overall Usage menu 740, where links to applications are organized by priority level and overall tracked usage, as well as a Daily Usage menu 750, a Weekly Usage menu 760, and a Monthly Usage menu 770. Selecting one of the listed menus may reveal a second nested menu or list containing the contents of the selected menu or list. For instance, in FIG. 7, the Weekly Usage menu 760 is selected and links or command pathways 780 to applications organized by priority level and weekly tracked usage may be displayed. In contrast to the inefficiency of selecting an application from a list of all applications, as shown by the All Programs 790 menu, the usage menus provide a computer operator with ease of use and greater efficiency when selecting a desired application.

The foregoing description presents the operation of the invention as an abstract entity within a computer system. In a simplified hierarchical view of a computer system, the computer system may include hardware and software layers. The computer hardware layer may be populated by computer processors, a memory system, and various input/output devices. The software layer may include both an operating system layer and an application program layer. Operating systems commercially available include the Windows operating systems commercially available from Microsoft Corp., the PalmOne operating system available from Palm Corp., the AIX operating system available from International Business Machines (IBM) Corp., and the Unix operating system available from Linux. The application layer may represent various application programs that may be executed by a computer. The application tracking and prioritization techniques described herein may be integrated into an operating system to provide more convenient and efficient control over computer operations and application selection. Furthermore, the principles of the foregoing embodiments may be used with any collection of application programs.

While the invention has been described with reference to the above embodiments, it is to be understood that these embodiments are purely exemplary in nature. Thus, the invention is not restricted to the particular forms shown in the foregoing embodiments. Various modifications and alterations can be made thereto without departing from the spirit and scope of the invention.

1. A method, comprising:
tracking usage of computer applications by a computer operator over time;
recording tracked usage of applications over a predetermined time interval;
presenting a user interface to the operator via a computer display, the user interface presenting a list of selected applications ordered according to a predetermined priority assignment, wherein with respect to applications having a common priority assignment, the applications are ordered according to tracked usage levels thereof.

2. The method of claim 1, wherein the list of selected applications includes command pathways to the selected applications.

3. The method of claim 1, wherein the list comprises a text file, a web page, a buffer file, or a database table.

4. The method of claim 1, wherein the tracked usage for each application is measured by the number of times each application is accessed.

5. The method of claim 1, wherein the tracked usage is recorded in a usage table.

6. The method of claim 1, wherein the predetermined time interval comprises a day, a week, or a month.

7. The method of claim 1, wherein the priority assignment comprises low, normal, or high.

8. The method of claim 7, wherein the predetermined priority assignment for each application is assigned by the computer operator or an administrator.

9. The method of claim 7, wherein the predetermined priority assignment for each of the applications is normal by default.

10. The method of claim 5, further comprising:
upon expiration of the predetermined time interval, transferring the corresponding tracked usage from the usage table to at least one backup table; and
resetting the transferred tracked usage in the usage table.

11. The method of claim 1, wherein the user interface is presented to the computer operator following authentication of the computer operator.

12. A computer system, comprising:
a usage monitor to track and record usage by an operator of computer applications over time; record within a usage table tracked usage of the applications over a predetermined time interval; and assign a priority level to each application recorded within the usage table, and
a user interface presenting command pathways to the computer applications, the user interface prioritizing the command pathways according to the applications' assigned priority levels and tracked usage.

13. The computer system of claim 12, wherein the usage monitor is further configured to create at least one menu containing the command pathways presented by the user interface.

14. The computer system of claim 13, wherein each of the at least one menu comprises a text file, a buffer file, a web page, or a database table.

15. The computer system of claim 12, wherein the predetermined time interval comprises a day, a week, or a month.

16. The computer system of claim 12, wherein the priority level for each application is assigned by the operator or an administrator.

17. The computer system of claim 15, wherein the usage monitor is further configured to:
upon expiration of the predetermined time interval, transfer the corresponding tracked usage from the usage table to at least one backup table; and
reset the transferred tracked usage in the usage table.

18. The computer system of claim 14, wherein the usage monitor is further configured to load the at least one menu following the authentication of the operator.

19. The computer system of claim 12, further comprising a graphical display unit to display the user interface.

20. A computer-readable storage medium storing a set of instructions, the set of instructions capable of causing a processor to implement a method comprising:
tracking usage of computer applications by a computer operator over time;
recording within a usage table tracked usage of applications over a predetermined time interval; and
assigning a priority level to each application listed in the usage table.

21. The computer-readable storage medium of claim 20, further comprising creating at least one menu containing links to the applications, the links being arranged by the priority level and tracked usage of applications.

22. The computer-readable storage medium of claim 21, wherein each of the at least one menu comprises a text file, a web page, a buffer file, or a database table.

23. The computer-readable storage medium of claim 20, wherein the predetermined time interval comprises a day, a week, or a month.

24. The computer-readable storage medium of claim 23, further comprising:
upon expiration of the predetermined time interval, transferring the corresponding tracked usage from the usage table to at least one backup table; and
resetting the transferred tracked usage in the usage table.

25. The computer-readable storage medium of claim 22, further comprising:
loading the at least one menu following authentication of the computer operator; and
displaying the at least one menu.

26. A method, comprising:
recording usage of application programs in a computer system over a plurality of periods having different lengths,
presenting in a computer user interface, command pathways representing the plurality of time periods,
when a pathway of one of the time periods is invoked, displaying in the user interface command pathways to select application programs according to relative priorities determined from the applications' recorded usage within the respective time period.
